(19) United States
(12) Patent Application Publication
(10) Pub. No.: US 2016/0366597 A1
(43) Pub. Date: Dec. 15, 2016

(54) COMMUNICATION DEVICE AND SCHEDULING METHOD

(71) Applicant: FUJITSU LIMITED, KAWASAKI-SHI (JP)

(72) Inventor: DAISUKE OGAWA, YOKOSUKA (JP)

(21) Appl. No.: 15/170,635

(22) Filed: Jun. 1, 2016

(30) Foreign Application Priority Data
Jun. 12, 2015 (JP) 2015-119784

(51) Int. Cl. H04W 24/02; H04W 72/12; H04B 17/336; H04W 72/04; H04J 11/00

(52) U.S. Cl. CPC H04W 24/02; H04W 72/0473; H04J 11/0023; H04B 17/336; H04W 72/1289

(57) ABSTRACT

A communication device includes a memory configured to store and associate a transmission power value of a signal and an error vector magnitude (EVM) power value which is a power value of noise corresponding to EVM; and a processor coupled with the memory, and configured to acquire the EVM power value corresponding to the transmission power value of the signal destined for a terminal group of a scheduling target from the memory and perform, by using the acquired EVM power value, a scheduler process of deciding a terminal combination which is a power allocation target and an allocation power value of each terminal of the decided terminal combination from a plurality of terminal combinations in the terminal group of the scheduling target, wherein the communication device is configured to be applied with a non-orthogonal multiple access scheme.

### CROSS-REFERENCE TO RELATED APPLICATION

This application is based upon and claims the benefit of priority of the prior Japanese Patent Application No. 2015-119784, filed on Jun. 12, 2015, the entire contents of which are incorporated herein by reference.

### FIELD

The embodiments discussed herein are related to a communication device and a scheduling method.

### BACKGROUND

Non-orthogonal multiple access schemes have been discussed for 5-generation mobile communication systems, the Institute of Electrical and Electronics Engineers, Inc. (IEEE), and the Institute of Electronics, Information and Communication Engineers (IEICE), for example. In the non-orthogonal multiple access, in a case in which time resources common to a plurality of users of scheduling targets are allocated, subbands (that is, non-orthogonal subbands) mutually interfering with one another are allocated to the users. That is, for example, as illustrated in FIG. 1, in a common subband, certain power is distributed (allocated) to users #1 and #2. FIG. 1 is a diagram illustrating non-orthogonal multiple access. In non-orthogonal multiple access systems, for example, reception side devices have a successive interference canceller (SIC) function. The SIC function is a function in which a reception side communication device cancels a signal destined for another communication device, to which the same resource as allocated to the reception side communication device is allocated, from a received signal and performs a demodulation process and a decoding process for the received signal subjected to the cancellation process. In non-orthogonal multiple access systems, signals destined for communication devices with a high signal to interference plus noise ratio (SINR) are transmitted with relatively small transmission power and signals destined for communication devices with low SINR are transmitted with relatively large transmission power.

For example, a case is assumed in which user #1 with high SINR near a base station and user #2 with low SINR distant from the base station are selected as two users that are targets for non-orthogonal multiplexing. Since the SINR of user #2 is low, a signal destined for user #2 is transmitted with larger transmission power than a signal destined for user #1. Therefore, user #1 may appropriately demodulate and decode the signal destined for 3 user #2. Accordingly, user #1 may easily remove interference from the signal destined for user #2 by cancelling the signal destined for user #2 from a received signal.

On the other hand, the signal destined for user #1 interferes in the signal destined for user #2, and thus causes deterioration in a channel capacity of user #2. However, since the SINR of user #2 is originally low, an influence of interference of the signal destined for user #1 is small.

Accordingly, according to the non-orthogonal multiple access, a sum of the channel capacities of all the users that are targets for multiplexing, that is, a total channel capacity, is expected to be improved.

Examples of the related art include: Anass Benjebbour et al., “Concept and Practical Considerations of Non-orthogonal Multiple Access (NOMA) for Future Radio Access”, ISPACS 2013; Keisuke Saito, Anass Benjebbour, Atsushi Harada, Yoshihisa Kishiyama, and Takehiro Nakamura, “Performance Evaluation of SIC Receiver considering Error Vector Magnitude for Downlink Non-orthogonal Multiple Access (NOMA)”, IEICE RCS 2014-163; Tomoya Fukami, Atsushi Tomiki, Hiromi Watanabe, Naohiko Iwakiri, Hirobumi Saito, and Shinichi Nakasuka, “Evaluation of the X-band High Speed Downlink Transmitter for Nano Satellite” IEICE General Conference 2013, B-2-60; and Takashi Seyama and Takashi Dateki, “Study on PF Scheduling for Downlink Non-orthogonal Multiple Access with SIC” IEICE RCS 2014-164.

However, in the non-orthogonal multiple access, there is a possibility of a total channel capacity deteriorating due to error vector magnitude (EVM).

That is, in the non-orthogonal multiple access of the related art, a scheduling index is used to decide a user combination which is a power allocation target and an allocation power value of each user of the user combination from a plurality of user combinations of a plurality of users of scheduling targets. Here, in the scheduling index used to decide each user combination and the allocation power value of each user of each user combination, a power value of noise corresponding to the EVM (hereinafter referred to as an “EVM power value”) is not considered. Accordingly, under an environment in which there is the EVM, a transmission power value which is a sum of the allocation power values for the users decided using the scheduling index is not appropriate. In a case in which a signal is transmitted with such a transmission power value, the channel capacity of each user may deteriorate due to an influence of the EVM power value. As a result, there is a concern of a sum of the channel capacities of all the users that are targets for multiplexing, that is, the total channel capacity, deteriorating.

The technology of the present disclosure is devised in light of the foregoing circumstances and an object of the technology of the present disclosure is to provide a communication device and a scheduling method capable of improving deterioration in a total channel capacity caused due to EVM in non-orthogonal multiple access.

### SUMMARY

According to an aspect of the embodiments, a communication device includes a memory configured to store and associate a transmission power value of a signal and an error vector magnitude (EVM) power value which is a power value of noise corresponding to EVM; and a processor coupled with the memory, and configured to acquire the EVM power value corresponding to the transmission power value of the signal destined for a terminal group of a scheduling target from the memory and perform, by using the acquired EVM power value, a scheduler process of deciding a terminal combination which is a power allocation target and an allocation power value of each terminal of the decided terminal combination from a plurality of terminal combinations in the terminal group of the scheduling target, wherein the communication device is configured to be applied with a non-orthogonal multiple access scheme.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating non-orthogonal multiple access;

FIG. 2 is a diagram illustrating deterioration in a total channel capacity caused due to EVM;

FIG. 3 is a diagram illustrating an example of a radio communication system including a base station according to Embodiment 1;

FIG. 4 is a block diagram illustrating an example of the configuration of the base station according to Embodiment 1;

FIG. 5 is a diagram illustrating an example of a correspondence relation between a transmission power value and EVM power value of a signal;

FIG. 6 is a block diagram illustrating an example of the configuration of a scheduler according to Embodiment 1;

FIG. 7 is a flowchart illustrating the flow of a process of an allocation power decision method according to Embodiment 1;

FIG. 8 is a block diagram illustrating an example of the configuration of a scheduler in a base station according to Embodiment 2;

FIG. 9 is a diagram illustrating a change in an allocation power value in a case of two-user multiplexing;

FIG. 10 is a flowchart illustrating the flow of a process of an allocation power decision method according to Embodiment 2;

FIG. 11 is a diagram illustrating advantages of the base station according to Embodiment 2;

FIG. 12 is a diagram (part 1) illustrating a change in an allocation power value in a case of three-user multiplexing;

FIG. 13 is a diagram (part 2) illustrating the change in allocation power values in the case of three-user multiplexing;

FIG. 14 is a block diagram illustrating an example of the configuration of a scheduler in a base station according to Embodiment 3;

FIG. 15 is a flowchart illustrating the flow of a process of an allocation power decision method according to Embodiment 3; and

FIG. 16 is a diagram illustrating an example of a hardware configuration of a base station.

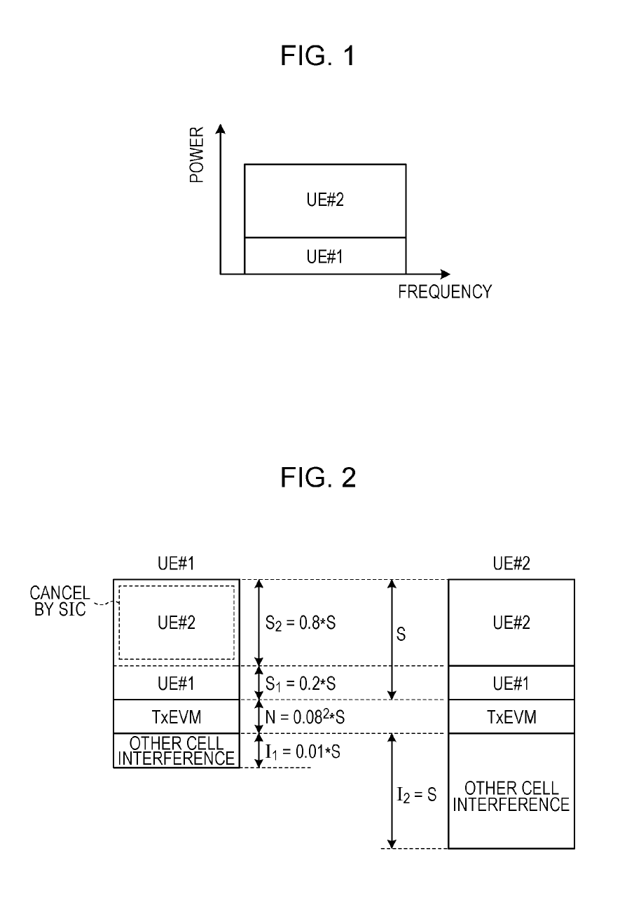

### DESCRIPTION OF EMBODIMENTS

Hereinafter, embodiments of a radio communication device and a scheduling method disclosed in the present application will be described in detail with reference to the drawings. The present technology is not limited to these embodiments.

First, with reference to FIG. 2, deterioration in a total channel capacity caused due to EVM will be described as a premise technology of a radio communication device disclosed in the present application. FIG. 2 is a diagram illustrating deterioration in a total channel capacity caused due to EVM. FIG. 2 illustrates a state of including user #1 with high instantaneous SINR close to a base station and user #2 with low instantaneous SINR distant from the base station as two users that are non-orthogonal multiplexing (scheduling) targets. In FIG. 2, S is assumed to be a transmission power value of a multiplexed signal obtained by multiplexing a signal destined for user #1 and a signal destined for user #2. S₁ is assumed to be a transmission power value (that is, an allocation power value of user #1) of a signal destined for user #1 and is 0.2 S, and S₂ is assumed to be a transmission power value (that is, an allocation power value of user #2) of a signal destined for user #2 and is 0.8 S. I₁ is assumed to be a power value of an interference signal from another base station to user #1 and is 0.01 S, and I₂ is assumed to be a power value of an interference signal from another base station to user #2 and is S.

First, a case in which it is assumed that there is no EVM will be described. A multiplexed signal obtained by multiplexing a signal destined for user #1 and a signal destined for user #2 is transmitted as a signal to be transmitted from the base station. The user #1 cancels the signal destined for user #2 using an SIC function. Therefore, the instantaneous SINR of user #1 is expressed as S₁/I₁. At this time, the channel capacity of user #1 is expressed as log₂ (1+S₁/I₁)=4.39 bps/Hz. On the other hand, the signal destined for user #1 causes interference with the signal destined for user #2. Therefore, the instantaneous SINR of user #2 is expressed as S₂/(S₁+I₂). At this time, the channel capacity of user #2 is expressed as log₂ {1+S₂/(S₁+I₂)}=0.74 bps/Hz. Accordingly, a sum of the channel capacity of user #1 and the channel capacity of user #2, that is, a total channel capacity, is 5.13 bps/Hz.

Conversely, a case in which there is the EVM will be described. For example, in Long Term Evolution-Advanced (LTE-A), an allowable value of the EVM is 8%. Therefore, a power value of noise corresponding to the EVM (hereinafter referred to as an “EVM power value”) is expressed as N=(0.08)²·S. For the signal destined for user #1 and the signal destined for user #2, the EVM becomes noise. Therefore, the instantaneous SINR of user #1 is expressed as S₁/(N+I₁) and the instantaneous SINR of user #2 is expressed as S₂/(S₁+N+I₂). At this time, the channel capacity of user #1 is expressed as log₂ {1+S₁/(N+I₁)}=3.72 bps/Hz and the channel capacity of user #2 is expressed as log₂ {1+S₂/(S₁+N+I₂)}=0.73 bps/Hz. Accordingly, a sum of the channel capacity of user #1 and the channel capacity of user #2, that is, a total channel capacity, is 4.45 bps/Hz.

As understood from the example of FIG. 2, in the case in which there is the EVM, the total channel capacity deteriorates further than in the case in which there is no EVM. In particular, a deterioration amount of the channel capacity of user #1 is greater than a deterioration amount of the channel capacity of user #2.

### Embodiment 1

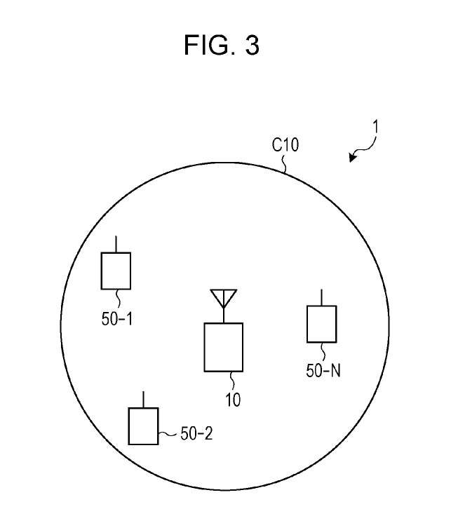

FIG. 3 is a diagram illustrating an example of a radio communication system including a base station according to Embodiment 1. In FIG. 3, a radio communication system 1 includes a base station 10 and terminals 50-1 to 50-N (where N is a natural number equal to or greater than 2). Hereinafter, when the terminals 50-1 to 50-N are not particularly distinguished from each other, the terminals 50-1 to 50-N are collectively referred to as a terminal 50 or terminals 50.

In FIG. 3, the terminals 50-1 to 50-N are located within a cell C10 of the base station 10. The base station 10 is a radio communication device to which a non-orthogonal multiple access scheme of allocating certain power to a plurality of terminals 50 in common carriers is applied. The base station 10 sets some or all of the terminals 50-1 to 50-N as scheduling targets. Herein, all of the terminals 50-1 to 50-N are set as the scheduling targets in the description.

The base station 10 includes a storage section that stores EVM power values in association with transmission power values of signals. The storage section includes a volatile storage medium and a nonvolatile storage medium. The volatile storage medium is, for example, a random access memory (RAM). The RAM is used as a work area of a CPU, a loading area of a program, or a storage area of data. The storage section may be a memory. The nonvolatile storage medium includes at least one selected from a read-only memory (ROM), a hard disk drive (HDD), a solid state drive (SSD), an electrically erasable programmable read-only memory (EEPROM), a flash memory, and the like. The base station 10 acquires from the storage section the EVM power values corresponding to the transmission power values of signals to the plurality of terminals 50 which are scheduling targets. Then, the base station 10 decides by using the acquired EVM power values a terminal combination which is a power allocation target and the allocation power value of each terminal 50 of the terminal combination from a plurality of terminal combinations of the plurality of terminals 50 which are scheduling targets.

For example, the base station 10 calculates the instantaneous SINR of each terminal 50 which is the scheduling target by using the EVM power value acquired from the storage section and calculates a scheduling index of each of the plurality of terminal combinations of the scheduling targets by using the instantaneous SINR. As the scheduling index, for example, a proportional fair (PF) metric or a channel capacity may be used. Hereinafter, the PF metric is used as the scheduling index in the description. Based on the calculated PF metric, the base station 10 decides the terminal combination which is the power allocation target and the allocation power value of each terminal 50 of the decided terminal combination from the plurality of terminal combinations of the scheduling targets.

Accordingly, since the base station 10 decides the power allocation target and the allocation power value of each terminal 50 by using the scheduling index calculated in consideration of the EVM, the base station 10 may transmit a signal with an appropriate transmission power value under an environment in which there is the EVM. As a result, it is possible to improve deterioration in the total channel capacity caused due to the EVM in the non-orthogonal multiple access.

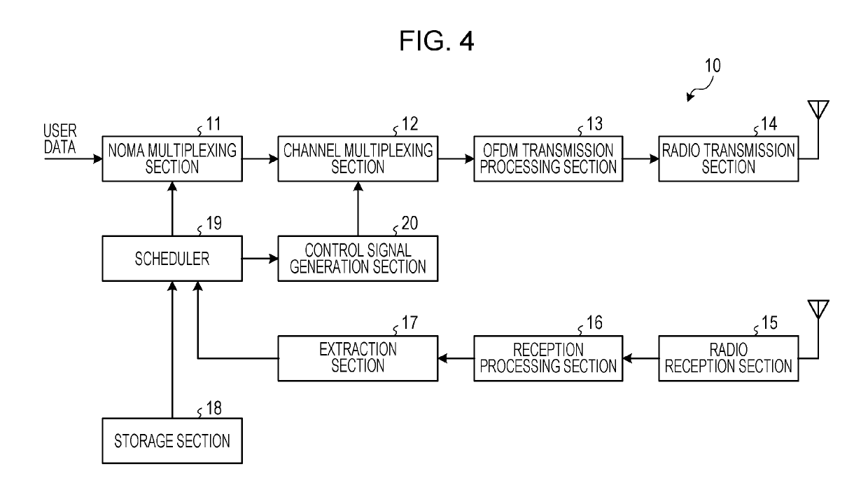

FIG. 4 is a block diagram illustrating an example of the configuration of the base station according to Embodiment 1. In FIG. 4, the base station 10 includes a non-orthogonal multiple access (NOMA) multiplexing section 11, a channel multiplexing section 12, an orthogonal frequency division multiple (OFDM) transmission processing section 13, and a radio transmission section 14. The base station 10 further includes a radio reception section 15, a reception processing section 16, an extraction section 17, a storage section 18, a scheduler 19, and a control signal generation section 20.

When the NOMA multiplexing section 11 receives scheduling information from the scheduler 19, the NOMA multiplexing section 11 performs an error correction code (ECC) process, a modulation process, and a power adjustment process on user data based on the scheduling information to generate a data signal. The scheduling information includes a modulation multi-value, a coding ratio, identification information of each terminal 50 of the terminal combination which is the non-orthogonal multiplexing target (power allocation target), and the allocation power value of each terminal 50. Then, the NOMA multiplexing section 11 performs non-orthogonal multiplexing on the generated data signal. Then, the NOMA multiplexing section 11 outputs the obtained multiplexed signal to the channel multiplexing section 12.

The channel multiplexing section 12 multiplexes a control signal received from the control signal generation section 20 and the multiplexed signal received from the NOMA multiplexing section 11. Here, orthogonal multiplexing is used rather than non-orthogonal multiplexing. Then, the channel multiplexing section 12 outputs the obtained multiplexed signal to the OFDM transmission processing section 13.

The OFDM transmission processing section 13 converts the multiplexed signal received from the channel multiplexing section 12 from a signal of a frequency domain to a signal of a time domain and adds a cyclic prefix (CP) to the obtained signal of the time domain to generate an OFDM signal.

The radio transmission section 14 performs a predetermined radio transmission process (digital-to-analog conversion, upconversion, amplification, or the like) on the OFDM signal generated by the OFDM transmission processing section 13 and transmits an obtained radio signal via an antenna.

The radio reception section 15 performs a predetermined radio reception process (downconversion or analog-to-digital conversion) on the radio signal received via the antenna and outputs an obtained signal to the reception processing section 16.

The reception processing section 16 performs a predetermined reception process (demodulation, decoding, or the like) on the signal received from the radio reception section 15 and outputs obtained received data to the extraction section 17.

The extraction section 17 extracts control data such as channel state information (CSI) from the data received from the reception processing section 16 and outputs extracted control data to the scheduler 19. The channel state information includes SINR reported from each terminal 50.

The control signal generation section 20 generates a control signal including the control information received from the scheduler 19 and outputs the generated control signal to the channel multiplexing section 12. The control information includes the identification information of each terminal 50 of the terminal combination which is the non-orthogonal multiplexing target (power allocation target), the allocation power value of each terminal 50, a coding ratio applied to a data signal of each terminal 50, and a modulation multi-value.

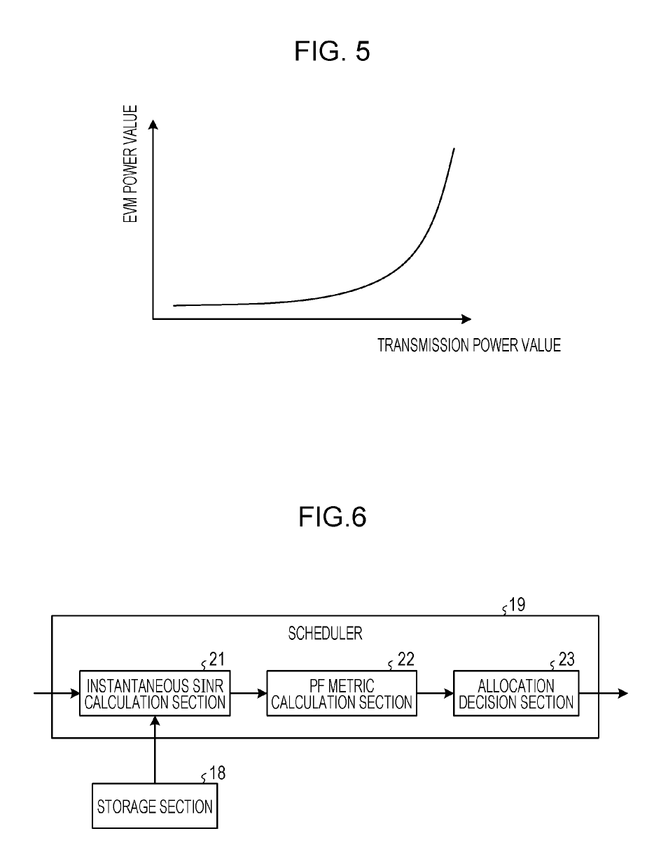

The storage section 18 stores the EVM power value in association with the transmission power value of the signal. FIG. 5 is a diagram illustrating an example of a correspondence relation between a transmission power value and EVM power value of a signal. As illustrated in FIG. 5, the larger the transmission power value of the signal is, the larger the EVM power value is. The storage section 18 stores, for example, the correspondence relation illustrated in FIG. 5 in the form of a table or an approximate function.

The scheduler 19 acquires from the storage section 18 the EVM power values corresponding to the transmission power values of the signals destined for the plurality of terminals 50 which are scheduling targets. Then, the scheduler 19 decides the terminal combination which is the power allocation target and an allocation power value of each terminal 50 of the decided terminal combination from the plurality of terminal combinations of the plurality of terminals 50 which are the scheduling targets by using the acquired EVM power values.

For example, the scheduler 19 includes an instantaneous SINR calculation section 21, a PF metric calculation section 22, and an allocation decision section 23, as illustrated in FIG. 6. FIG. 6 is a block diagram illustrating an example of the configuration of the scheduler according to Embodiment 1.

The instantaneous SINR calculation section 21 acquires the EVM power values corresponding to the transmission power values of the signals destined for the plurality of terminals 50 which are the scheduling targets from the storage section 18. Then, the instantaneous SINR calculation section 21 calculates the instantaneous SINR of each terminal 50 which is the scheduling target by using the EVM power values acquired from the storage section 18. That is, the instantaneous SINR calculation section 21 calculates the instantaneous SINR of each power distribution candidate for each terminal 50 which is the scheduling target. Then, the instantaneous SINR calculation section 21 outputs the calculated instantaneous SINR of each terminal 50 to the PF metric calculation section 22. The instantaneous SINR calculation section 21 corresponds to an example of a first calculation section.

Here, for example, calculation of the instantaneous SINR in a case of two-user multiplexing will be examined. In the case of the two-user multiplexing, the instantaneous SINR of user #1 and the instantaneous SINR of user #2 are calculated by formulae (1) and (2) below.

$$\begin{matrix}{γ}_{1} = \frac{{S}_{1}}{N + \frac{( {S}_{1}^{( CSI )} - {γ}_{1}^{( CSI )} {N}_{1}^{( CSI )} )}{{γ}_{1}^{( CSI )}}} & ( 1 ) \\ {γ}_{2} = \frac{{S}_{2}}{{S}_{1} + N + \frac{( {S}_{2}^{( CSI )} - {γ}_{2}^{( CSI )} {N}_{2}^{( CSI )} )}{{γ}_{2}^{( CSI )}}} & ( 2 )\end{matrix}$$

Here, user #1 is assumed to be a user with high instantaneous SINR close to the base station 10 and user #2 is assumed to be a user with low instantaneous SINR distant from the base station 10. γ₁^{(CSI)} is assumed to be an SINR reported from user #1 to the base station 10 and γ₂^{(CSI)} is assumed to be an SINR reported from user #2 to the base station 10. S₁^{(CSI)} is assumed to be a transmission power value of a pilot signal destined for user #1 and S₂^{(CSI)} is assumed to be a transmission power value of a pilot signal destined for user #2. N₁^{(CSI)} is assumed to be a power value of noise added as the EVM to the pilot signal destined for user #1 and N₂^{(CSI)} is assumed to be a power value of noise added as the EVM to the pilot signal destined for user #2. S₁ is assumed to be a transmission power value of the signal destined for user #1 (that is, an allocation power value of user #1) and S₂ is assumed to be a transmission power value of the signal destined for user #2 (that is, an allocation power value of user #2). N is assumed to be a power value of noise added as the EVM to the transmission power value of the multiplex signal obtained by multiplexing the signal destined for user #1 and the signal destined for user #2. S₁ and S₂ are parameters for changing the power distribution. γ₁^{(CSI)}, γ₂^{(CSI)}, S₁^{(CSI)}, and S₂^{(CSI)} are known values and are managed on the base station 10 side.

That is, in the case of the two-user multiplexing, the instantaneous SINR calculation section 21 acquires N₁^{(CSI)} corresponding to S₁^{(CSI)}, N₂^{(CSI)} corresponding to S₂^{(CSI)}, and N corresponding to (S₁+S₂) as EVM power values with reference to the storage section 18. Then, the instantaneous SINR calculation section 21 applies the acquired N₁^{(CSI)}, N₂^{(CSI)}, and N to formulae (1) and (2) to calculate the instantaneous SINR of user #1 and the instantaneous SINR of user #2.

Next, a process of deriving formulae (1) and (2) above will be described.

The SINR reported from user #1 to the base station 10 and the SINR reported from user #2 to the base station 10 are expressed as formulae (3) and (4) below, respectively.

$$\begin{matrix}{γ}_{1}^{( CSI )} = \frac{{α}_{1} {S}_{1}^{( CSI )}}{{α}_{1} {N}_{1}^{( CSI )} + {I}_{1}} & ( 3 ) \\ {γ}_{2}^{( CSI )} = \frac{{α}_{2} {S}_{2}^{( CSI )}}{{α}_{2} {N}_{2}^{( CSI )} + {I}_{2}} & ( 4 )\end{matrix}$$

Here, α₁ is assumed to be an attenuation coefficient of a transmission path between the base station 10 and user #1 and α₂ is assumed to be an attenuation coefficient of a transmission path between the base station 10 and user #2. Further, I₁ is assumed to be a power value of an interference signal from another base station to user #1 and I₂ is assumed to be a power value of an interference signal from another base station to user #2.

The instantaneous SINR of user #1 and the instantaneous SINR of user #2 are expressed as formulae (5) and (6) below, respectively.

$$\begin{matrix}{γ}_{1} = \frac{{α}_{1} {S}_{1}}{{α}_{1} N + {I}_{1}} & ( 5 ) \\ {γ}_{2} = \frac{{α}_{2} {S}_{2}}{{α}_{2} {S}_{1} + {α}_{2} N + {I}_{2}} & ( 6 )\end{matrix}$$

Accordingly, formula (1) is derived by removing I₁ in accordance with formulae (3) and (5). Further, formula (2) is derived by removing I₂ in accordance with formulae (4) and (6).

The PF metric calculation section 22 calculates a PF metric which is a scheduling index for each of the plurality of terminal combinations of the scheduling targets. Specifically, the PF metric calculation section 22 calculates a PF metric for each of the plurality of terminal combinations of the scheduling targets by using the instantaneous SINR received from the instantaneous SINR calculation section 21. The PF metric may be calculated using a known scheme. For example, the PF metric calculation section 22 calculates a ratio of the instantaneous SINR to an average SINR as the PF metric. The PF metric calculation section 22 may maintain a table in which the instantaneous SINRs are associated with throughput expectation values and specify with reference to the table the throughput expectation value corresponding to the instantaneous SINR received from the instantaneous SINR calculation section 21 as the PF metric. The PF metric calculation section 22 may set a value obtained by dividing the throughput expectation value specified from the table by an average throughput as the PF metric. The PF metric calculation section 22 corresponds to an example of a second calculation section.

Based on the PF metric, the allocation decision section 23 decides the terminal combination which is the power allocation target and the allocation power value of each terminal 50 of the decided terminal combination from the plurality of terminal combinations of the scheduling targets.

That is, the allocation decision section 23 decides as the power allocation target the terminal combination corresponding to the PF metric with the maximum value among the plurality of PF metrics calculated by the PF metric calculation section 22. The allocation decision section 23 decides the allocation power value to be applied to the data signal destined for each terminal 50 of the terminal combination corresponding to the PF metric with the maximum value among the plurality of PF metrics calculated by the PF metric calculation section 22 as the allocation power value of each terminal 50 of the power allocation target. The allocation decision section 23 decides the coding ratio and the modulation multi-value to be applied to the data signal destined for each terminal 50 of the terminal combination of the decided power allocation target. The allocation decision section 23 generates the foregoing scheduling information and control information and outputs the generated scheduling information and control information to each of the NOMA multiplexing section 11 and the control signal generation section 20. The allocation decision section 23 corresponds to an example of a decision section.

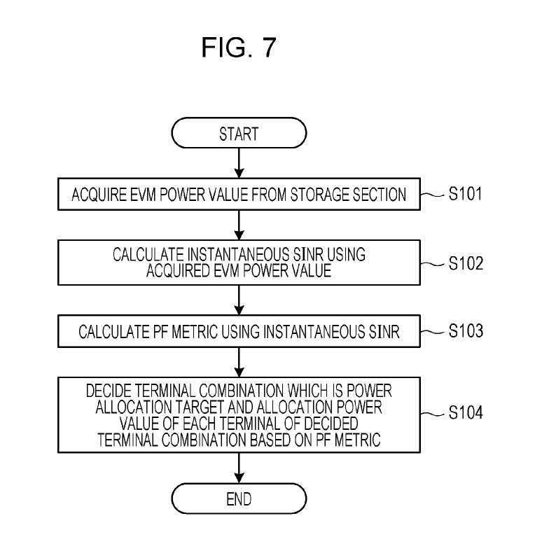

Next, an example of a processing operation of the radio communication system 1 according to Embodiment 1 will be described. In particular, herein, an allocation power decision method by the scheduler 19 of the base station 10 will be described. FIG. 7 is a flowchart illustrating the flow of a process of the allocation power decision method according to Embodiment 1.

As illustrated in FIG. 7, the instantaneous SINR calculation section 21 of the scheduler 19 acquires the EVM power values corresponding to the transmission power values of the signals destined for the plurality of terminals 50 which are the scheduling targets from the storage section 18 storing the EVM power values in association with the transmission power values of the signals (S101).

The instantaneous SINR calculation section 21 calculates the instantaneous SINR of each terminal 50 which is the scheduling target using the acquired EVM power value (S102).

The PF metric calculation section 22 calculates a PF metric for each of the plurality of terminal combinations of the scheduling targets using the instantaneous SINR (S103).

Based on the PF metric, the allocation decision section 23 decides the terminal combination which is the power allocation target and the allocation power value of each terminal 50 of the decided terminal combination from the plurality of terminal combinations of the scheduling targets (S104).

According to the embodiment, as described above, the base station 10 is a radio communication device to which the non-orthogonal multiple access scheme is applied. In the base station 10, the storage section 18 associates and stores the transmission power values of the signals and the EVM power values. In the base station 10, the scheduler 19 acquires from the storage section 18 the EVM power value corresponding to the transmission power value of a signal destined for a group of the terminals 50 which are the scheduling targets. In the base station 10, the scheduler 19 decides the terminal combination which is the power allocation target and the allocation power value of each terminal 50 of the decided terminal combination from the plurality of terminal combinations in the group of the terminals 50 which are the scheduling targets by using the acquired EVM power value.

In the configuration of the base station 10, the scheduling index calculated in consideration of the EVM is used to decide the power allocation target and the allocation power value of each terminal 50. Therefore, under the environment in which there is the EVM, a signal may be transmitted with an appropriate transmission power value. As a result, it is possible to improve the deterioration in the total channel capacity caused due to the EVM in the non-orthogonal multiple access.

### Embodiment 2

Embodiment 2 is related to a variation in a method of deciding the allocation power value of each terminal 50 of the terminal combination which is the power allocation target. The basic configuration of a base station according to Embodiment 2 is the same as that of the base station 10 according to Embodiment 1.

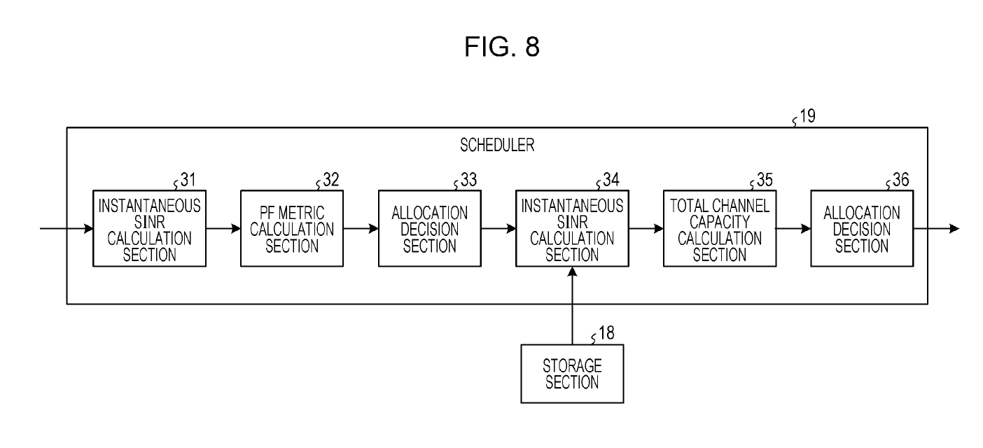

In the base station 10 according to Embodiment 2, as illustrated in FIG. 8, the scheduler 19 includes an instantaneous SINR calculation section 31, a PF metric calculation section 32, an allocation decision section 33, an instantaneous SINR calculation section 34, a total channel capacity calculation section 35, and an allocation decision section 36. FIG. 8 is a block diagram illustrating an example of the configuration of a scheduler in a base station according to Embodiment 2. Hereinafter, a method of deciding the allocation power value of, for example, a case of two-user multiplexing will be described.

The instantaneous SINR calculation section 31 calculates an instantaneous SINR for each of first and second terminals 50 which are scheduling targets. Here, in the calculation of the instantaneous SINR by the instantaneous SINR calculation section 31, the EVM power value stored in the storage section 18 is not used.

The PF metric calculation section 32 calculates PF metrics which are the scheduling index in the terminal combination including the first and second terminals 50 by using the calculated instantaneous SINR without using the EVM power value by the instantaneous SINR calculation section 31.

The allocation decision section 33 decides, as the power allocation target, the terminal combination corresponding to the PF metric with the maximum value among the plurality of PF metrics calculated by the PF metric calculation section 32. The allocation decision section 33 decides, as the allocation power value of each terminal 50 of the power allocation target, the allocation power value applied to a data signal destined for each terminal 50 of the terminal combination corresponding to the PF metric with the maximum value among the plurality of PF metrics calculated by the PF metric calculation section 32. In the following description, it is assumed that the allocation decision section 33 decides the terminal combination including the first and second terminals 50 as the power allocation target, S₁ is decided as the allocation target value of the first terminal 50, and S₂ (>S₁) is decided as the allocation power value of the second terminal 50. The allocation decision section 33 outputs the allocation power value S₁ of the first terminal 50 and the allocation power value S₂ of the second terminal 50, which are temporarily decided without using the EVM power value, to the instantaneous SINR calculation section 34.

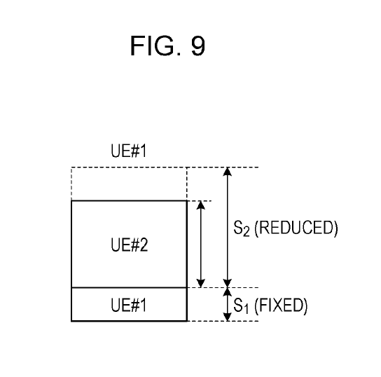

The instantaneous SINR calculation section 34 acquires from the allocation decision section 33 the allocation power value S₁ of the first terminal 50 and the allocation power value S₂ (>S₁) of the second terminal 50, which are temporarily decided without using the EVM power value, in the terminal combination including the first and second terminals 50. As illustrated in FIG. 9, the instantaneous SINR calculation section 34 reduces the allocation power value S₂ of the second terminal 50 in a state of the allocation power value S₁ of the first terminal 50 being fixed. FIG. 9 is a diagram illustrating a change in an allocation power value in a case of two-user multiplexing.

The instantaneous SINR calculation section 34 acquires the EVM power value corresponding to a transmission power value S′, which is a sum of the reduced allocation power value S₂′ of the second terminal 50 and the allocation power value S₁ of the first terminal 50 which is a fixed value, from the storage section 18. Then, the instantaneous SINR calculation section 34 calculates an instantaneous SINR for each of the first and second terminals 50 using the acquired EVM power value. That is, the instantaneous SINR calculation section 34 calculates an instantaneous SINR of each candidate of the power distribution for each of the first and second terminals 50. Then, the instantaneous SINR calculation section 34 outputs the calculated instantaneous SINR of each of the first and second terminals 50 to the total channel capacity calculation section 35. The instantaneous SINR calculation section 34 corresponds to an example of a first calculation section.

Here, the instantaneous SINRs of the first and second terminals 50 are calculated by formulae (7) and (8), respectively.

$$\begin{matrix}{γ}_{1} ( {S}_{1} , {S}_{2}^{′} ) = \frac{{S}_{1}}{N ( {S}_{1} , {S}_{2}^{′} ) + \frac{( {S}_{1}^{( CSI )} - {γ}_{1}^{( CSI )} {N}_{1}^{( CSI )} )}{{γ}_{1}^{( CSI )}}} & ( 7 ) \\ {γ}_{2} ( {S}_{1} , {S}_{2}^{′} ) = \frac{{S}_{2}^{′}}{{S}_{1} + N ( {S}_{1} , {S}_{2}^{′} ) + \frac{( {S}_{2}^{( CSI )} - {γ}_{2}^{( CSI )} {N}_{2}^{( CSI )} )}{{γ}_{2}^{( CSI )}}} & ( 8 )\end{matrix}$$

Here, user #1 (the first terminal 50) is assumed to be a user with high instantaneous SINR close to the base station 10 and user #2 (the second terminal 50) is assumed to be a user with low instantaneous SINR distant from the base station 10. γ₁^{(CSI)} is assumed to be an SINR reported from user #1 to the base station 10 and γ₂^{(CSI)} is assumed to be an SINR reported from user #2 to the base station 10. S₁^{(CSI)} is assumed to be a transmission power value of a pilot signal destined for user #1 and S₂^{(CSI)} is assumed to be a transmission power value of a pilot signal destined for user #2. N₁^{(CSI)} is assumed to be a power value of noise added as the EVM to the pilot signal destined for user #1 and N₂^{(CSI)} is assumed to be a power value of noise added as the EVM to the pilot signal destined for user #2. S₁ is assumed to be a transmission power value of the signal destined for user #1 (that is, an allocation power value of the first terminal 50) and S₂′ is assumed to be a transmission power value of the signal destined for user #2 (that is, a reduced allocation power value of the second terminal 50). N (S₁, S₂′) is assumed to be a power value of noise added as the EVM to the transmission power value (that is, the sum of the reduced allocation power value of the second terminal 50 and the allocation power value of the first terminal which is the fixed value) of the multiplex signal obtained by multiplexing the signal destined for user #1 and the signal destined for user #2. S₂′ is a parameter for changing the power distribution. γ₁^{(CSI)}, γ₂^{(CSI)}, S₁^{(CSI)}, and S₂^{(CSI)} are known values and are managed on the base station 10 side.

That is, the instantaneous SINR calculation section 34 acquires N₁^{(CSI)} corresponding to S₁^{(CSI)}, N₂^{(CSI)} corresponding to S₂^{(CSI)}, and N (S₁, S₂′) corresponding to (S₁+S₂′) as EVM power values with reference to the storage section 18. Then, the instantaneous SINR calculation section 34 applies the acquired N₁^{(CSI)}, N₂^{(CSI)}, and N (S₁, S₂′) to formulae (7) and (8) to calculate the instantaneous SINRs of the first and second terminals 50.

The total channel capacity calculation section 35 calculates the total channel capacity which is the scheduling index for the terminal combination including the first and second terminals 50 by using the instantaneous SINRs received from the instantaneous SINR calculation section 34. The total channel capacity calculation section 35 corresponds to an example of a second calculation section. For example, the total channel capacity calculation section 35 calculates the total channel capacity for the terminal combination including the first and second terminals 50 by using formula (9) below.

C(S₁,S₂′)=log₂ {1+γ₁(S₁,S₂′)}+log₂ {1+γ₂(S₁,S₂′)} (9)

Here, γ₁(S₁, S₂′) and γ₂(S₁, S₂′) indicate the instantaneous SINR of the first terminal 50 and the instantaneous SINR of the second terminal 50, respectively.

The allocation decision section 36 re-decides the allocation power value S₂ of the second terminal 50 based on the total channel capacity. Specifically, the allocation decision section 36 sets, as a new allocation power value S₂ of the second terminal 50, the reduced allocation power value S₂′ of the second terminal 50 corresponding to the total channel capacity with the maximum value among the plurality of total capacity channels calculated by the total channel capacity calculation section 35. The allocation decision section 36 corresponds to an example of a decision section.

For example, the allocation decision section 36 re-decides the allocation power value S₂ of the second terminal 50 by using formula (10) below.

$${S}_{2} = arg {max}_{{S}_{2}^{′}} C ( {S}_{1} , {S}_{2}^{′} ) \qquad ( 10 )$$

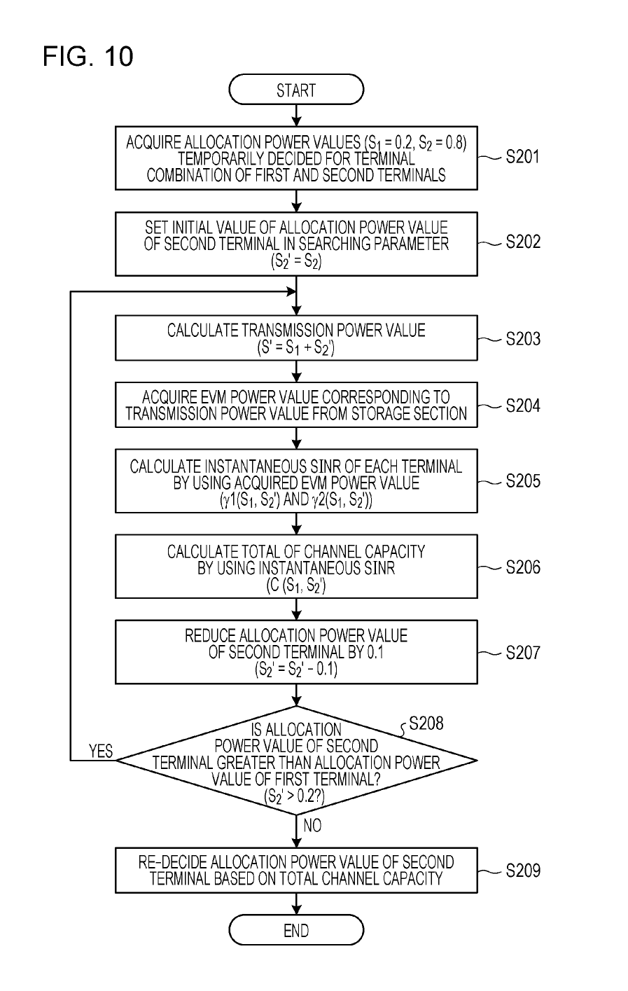

Next, an example of a processing operation of the radio communication system according to Embodiment 2 will be described. In particular, an allocation power decision method by the scheduler 19 of the base station 10 will be described. FIG. 10 is a flowchart illustrating the flow of a process of an allocation power decision method according to Embodiment 2.

As illustrated in FIG. 10, the instantaneous SINR calculation section 34 acquires the allocation power value S₁ of the first terminal 50 and the allocation power value S₂ of the second terminal 50, which are temporarily decided for the terminal combination including the first and second terminals 50, from the allocation decision section 33 (S201). Here, 0.2 is decided as the allocation power value S₁ of the first terminal 50 and 0.8 is decided as the allocation power value S₂ of the second terminal 50.

The instantaneous SINR calculation section 34 sets an initial value 0.8 of the allocation power value S₂ of the second terminal 50 in a searching parameter (S202). The searching parameter is a parameter used to search for the reduced allocation power value S₂′ of the second terminal 50.

The instantaneous SINR calculation section 34 calculates the transmission power value S′ which is the sum of the reduced allocation power value S₂′ of the second terminal 50 and the allocation power value S₁ of the first terminal 50 which is the fixed value (S203).

The instantaneous SINR calculation section 34 acquires the EVM power value corresponding to the transmission power value S′ from the storage section 18 (S204).

The instantaneous SINR calculation section 34 calculates an instantaneous SINR for each of the first and second terminals 50 by using the acquired EVM power value (S205). That is, the instantaneous SINR calculation section 34 calculates the instantaneous SINR of each of the first and second terminals 50 by applying the acquired EVM power value to each of formulae (7) and (8) above.

The total channel capacity calculation section 35 calculates the total channel capacity which is the scheduling index for the terminal combination including the first and second terminals 50 by using the instantaneous SINRs received from the instantaneous SINR calculation section 34 (S206). That is, the total channel capacity calculation section 35 calculates the total channel capacity for the terminal combination including the first and second terminals 50 by using formula (9) above.

The instantaneous SINR calculation section 34 reduces the allocation power value S₂ of the second terminal 50 by 0.1 in the state of the allocation power value S₁ of the first terminal 50 being fixed (S207). The reduction amount of the allocation power value S₂ of the second terminal 50 is not limited to 0.1.

The instantaneous SINR calculation section 34 returns to the process of S203 when the reduced allocation power value S₂′ of the second terminal 50 is greater than the allocation power value S₁ of the first terminal 50 which is the fixed value (YES in S208).

The instantaneous SINR calculation section 34 allows to the process to proceed to S209 when the reduced allocation power value S₂′ of the second terminal 50 is equal to or less than the allocation power value S₁ of the first terminal 50 which is the fixed value (NO in S208).

The allocation decision section 36 re-decides the allocation power value S₂ of the second terminal based on the total channel capacity (S209). That is, the allocation decision section 36 re-decides the allocation power value S₂ of the second terminal 50 by using formula (10) above.

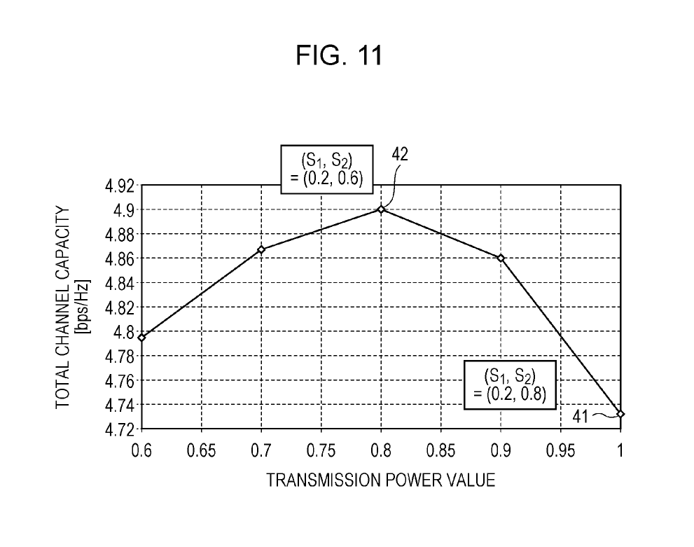

FIG. 11 is a diagram illustrating advantages of the base station according to Embodiment 2. FIG. 11 is a diagram illustrating a simulation result indicating an example of a relation between the transmission power value and the total channel capacity.

In FIG. 11, the vertical axis represents the total channel capacity and the horizontal axis represents the transmission power value which is the sum of the allocation power value of the first terminal and the allocation power value of the second terminal. In FIG. 11, a measurement point 41 is a point indicating a relation between the transmission power value and the total channel capacity in a case in which the allocation power value S₁ of the first terminal 50 and the allocation power value S₂ of the second terminal 50 which are temporarily decided without using the EVM power value are used. In the example of FIG. 11, the allocation power value S₁ of the first terminal 50 and the allocation power value S₂ of the second terminal 50 which are temporarily decided without using the EVM power value are assumed to be 0.2 and 0.8, respectively.

On the other hand, a measurement point 42 is a point indicating a relation between the transmission power value and the total channel capacity in a case in which the transmission power value which is a sum of the allocation power value S₁ of the first terminal 50 and the allocation power value S₂ of the second terminal 50 re-decided by the base station 10 according to the embodiment is used. In the example of FIG. 11, the allocation power value S₂ of the second terminal 50 re-decided by the base station 10 is assumed to be 0.6.

As illustrated in FIG. 11, the base station 10 according to the embodiment may improve the total channel capacity by 3.5% compared to the case in which the allocation power value S₁ of the first terminal 50 and the allocation power value S₂ of the second terminal 50 which are temporarily decided without using the EVM power value are used.

According to the embodiment, as described above, the instantaneous SINR calculation section 34 in the base station 10 acquires the allocation power value S₁ of the first terminal 50 and the allocation power value S₂ of the second terminal 50 which are temporarily decided without using the EVM power value for the terminal combination including the first and second terminals 50. Then, the instantaneous SINR calculation section 34 reduces the allocation power value S₂ of the second terminal 50 greater than the allocation power value S₁ of the first terminal 50. Then, the instantaneous SINR calculation section 34 acquires from the storage section 18 the EVM power value corresponding to the transmission power value S′ which is the sum of the reduced allocation power value S₂′ of the second terminal 50 and the allocation power value S₁ of the first terminal 50 which is the fixed value. Then, the instantaneous SINR calculation section 34 calculates an instantaneous SINR for each of the first and second terminals 50 by using the acquired EVM power value. The total channel capacity calculation section 35 calculates the total channel capacity which is the scheduling index for the terminal combination including the first and second terminals 50 by using the instantaneous SINRs received from the instantaneous SINR calculation section 34. The allocation decision section 36 re-decides the allocation power value S₂ of the second terminal 50 based on the total channel capacity.

In the configuration of the base station 10, the scheduling index in consideration of the EVM is calculated for the terminal combination including two terminals. Therefore, the terminal combinations of scheduling index calculation targets may be narrowed down. As a result, according to the embodiment, it is possible to improve the deterioration in the total channel capacity caused due to the EVM and it is possible to reduce an amount of calculation to calculate the scheduling index.

### Modification 1 of Embodiment 2

In the embodiment, the example in which the instantaneous SINR calculation section 34 changes the allocation power value in the case of the two-user multiplexing has been described. However, a maximum allocation power value of a user may be changed in a case of multiplexing of a plurality of users equal to or more three users. For example, a change in the allocation power value in a case of three-user multiplexing will be described below.

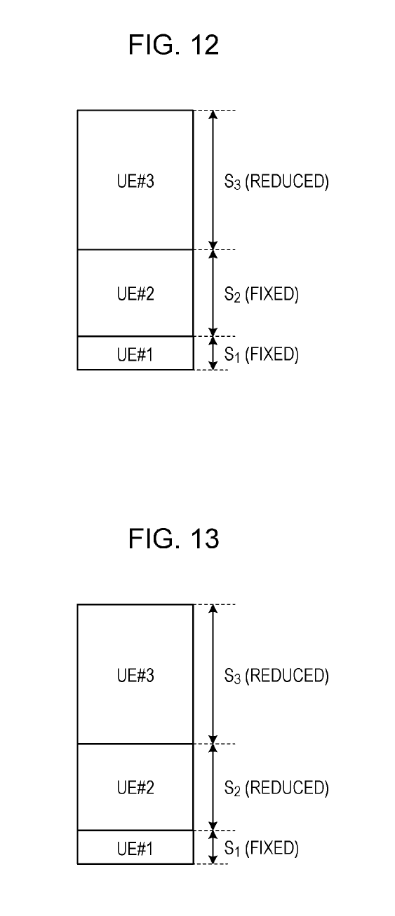

FIG. 12 is a diagram (part 1) illustrating a change in an allocation power value in a case of the three-user multiplexing. As illustrated in FIG. 12, the instantaneous SINR calculation section 34 acquires from the allocation decision section 33 allocation power values S₁ to S₃ (where S₁<S₂<S₃) of three terminals 50 which are temporarily decided without using the EVM power value for the terminal combination including the three terminals 50. The instantaneous SINR calculation section 34 reduces the maximum allocation power value S₃ of the terminal 50 among the allocation power values of the three terminals 50. Then, the instantaneous SINR calculation section 34 acquires from the storage section 18 the EVM power value corresponding to a transmission power value which is a sum of the reduced maximum allocation power value S₃′ of the terminal 50 and the allocation power values of the other two terminals 50 which are fixed values. Then, the instantaneous SINR calculation section 34 calculates an instantaneous SINR for each of the three terminals 50 by using the acquired EVM power value. Then, the instantaneous SINR calculation section 34 outputs the acquired instantaneous SINR of each of the three terminals 50 to the total channel capacity calculation section 35.

In a case in which the allocation power values illustrated in FIG. 12 are changed, the total channel capacity calculation section 35 calculates the total channel capacity which is the scheduling index for the terminal combination including the three terminals 50 by using the instantaneous SINRs received from the instantaneous SINR calculation section 34. The allocation decision section 36 re-decides the maximum allocation power value of the terminal 50 based on the total channel capacity.

### Modification 2 of Embodiment 2

The instantaneous SINR calculation section 34 may change the allocation power values of high-rank N users (where N is a natural number equal to or less than Nₘₐₓ when the maximum of non-orthogonal multiple numbers is Nₘₐₓ) in a case of a plurality of users equal to or greater than three or more users being multiplexed. For example, a change in allocation power values in the case of three-user multiplexing will be described below.

FIG. 13 is a diagram (part 2) illustrating the change in the allocation power values in the case of three-user multiplexing. As illustrated in FIG. 13, the instantaneous SINR calculation section 34 acquires from the allocation decision section 33 allocation power values S₁ to S₃ (where S₁<S₂<S₃) of three terminals 50 which are temporarily decided without using the EVM power value for the terminal combination including the three terminals 50. The instantaneous SINR calculation section 34 reduces the two high-rank allocation power values S₂ and S₃ of the terminal 50 among the allocation power values of the three terminals 50. Then, the instantaneous SINR calculation section 34 acquires from the storage section 18 the EVM power value corresponding to a transmission power value which is a sum of the reduced maximum allocation power values S₂′ and S₃′ of the terminals 50 and the allocation power value of the other terminal 50 which is a fixed value. Then, the instantaneous SINR calculation section 34 calculates an instantaneous SINR for each of the two high-rank terminals 50 by using the acquired EVM power value. Then, the instantaneous SINR calculation section 34 outputs the calculated instantaneous SINR of each of the two terminals 50 to the total channel capacity calculation section 35.

In a case in which the allocation power values illustrated in FIG. 13 are changed, the total channel capacity calculation section 35 calculates the total channel capacity which is the scheduling index for the terminal combination including the two high-rank terminals 50 by using the instantaneous SINRs received from the instantaneous SINR calculation section 34. The allocation decision section 36 re-decides the allocation power values of the two high-rank terminals 50 based on the total channel capacity.

### Embodiment 3

Embodiment 3 is related to a variation in a method of deciding the allocation power value of each terminal 50 of the terminal combination which is the power allocation target. The basic configuration of a base station according to Embodiment 3 is the same as that of the base station 10 according to Embodiment 2.

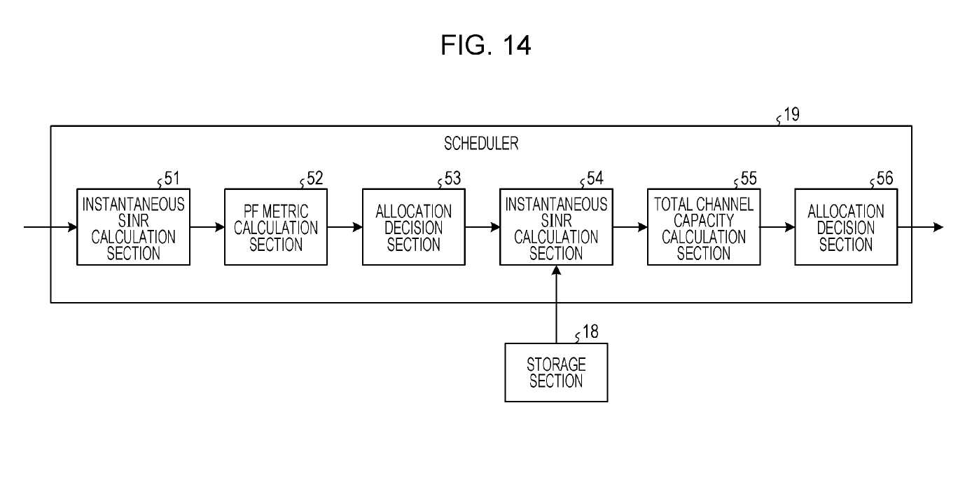

In the base station 10 according to Embodiment 3, as illustrated in FIG. 14, the scheduler 19 includes an instantaneous SINR calculation section 51, a PF metric calculation section 52, an allocation decision section 53, an instantaneous SINR calculation section 54, a total channel capacity calculation section 55, and an allocation decision section 56. FIG. 14 is a block diagram illustrating an example of the configuration of a scheduler in a base station according to Embodiment 3. Hereinafter, a method of deciding the allocation power value of, for example, a case of two-user multiplexing will be described.

The instantaneous SINR calculation section 51, the PF metric calculation section 52, and the allocation decision section 53 correspond to the instantaneous SINR calculation section 31, the PF metric calculation section 32, the allocation decision section 33 according to Embodiment 2, respectively.

The instantaneous SINR calculation section 54 acquires from the allocation decision section 53 the allocation power value S₁ of the first terminal 50 and the allocation power value S₂ (>S₁) of the second terminal 50, which are temporarily decided without using the EVM power value, in the terminal combination including the first and second terminals 50. The instantaneous SINR calculation section 54 reduces the transmission power value S which is a sum of the allocation power value S₁ of the first terminal 50 and the allocation power value S₂ of the second terminal 50 in a fixed state of a ratio of the allocation power value S₁ of the first terminal 50 to the allocation power value S₂ of the second terminal 50.

The instantaneous SINR calculation section 54 acquires the EVM power value corresponding to a reduced transmission power value S′ from the storage section 18. Then, the instantaneous SINR calculation section 54 calculates an instantaneous SINR for each of the first and second terminals 50 using the acquired EVM power value. That is, the instantaneous SINR calculation section 54 calculates an instantaneous SINR of each candidate of the power distribution for each of the first and second terminals 50. Then, the instantaneous SINR calculation section 54 outputs the calculated instantaneous SINR of each of the first and second terminals 50 to the total channel capacity calculation section 55. The instantaneous SINR calculation section 54 corresponds to an example of the first calculation section.

Here, the instantaneous SINRs of the first and second terminals 50 are calculated by formulae (11) and (12), respectively.

$$\begin{matrix}{γ}_{1} ( {S}_{1}^{′} , {S}_{2}^{′} ) = \frac{{S}_{1}^{′}}{N ( {S}_{1}^{′} , {S}_{2}^{′} ) + \frac{( {S}_{1}^{( CSI )} - {γ}_{1}^{( CSI )} {N}_{1}^{( CSI )} )}{{γ}_{1}^{( CSI )}}} & ( 11 ) \\ {γ}_{2} ( {S}_{1}^{′} , {S}_{2}^{′} ) = \frac{{S}_{2}^{′}}{{S}_{1}^{′} + N ( {S}_{1}^{′} , {S}_{2}^{′} ) + \frac{( {S}_{2}^{( CSI )} - {γ}_{2}^{( CSI )} {N}_{2}^{( CSI )} )}{{γ}_{2}^{( CSI )}}} . & ( 12 )\end{matrix}$$

Here, user #1 (the first terminal 50) is assumed to be a user with high instantaneous SINR close to the base station 10 and user #2 (the second terminal 50) is assumed to be a user with low instantaneous SINR distant from the base station 10. γ₁^{(CSI)} is assumed to be an SINR reported from user #1 to the base station 10 and γ₂^{(CSI)} is assumed to be an SINR reported from user #2 to the base station 10. S₁^{(CSI)} is assumed to be a transmission power value of a pilot signal destined for user #1 and S₂^{(CSI)} is assumed to be a transmission power value of a pilot signal destined for user #2. N₁^{(CSI)} is assumed to be a power value of noise added as the EVM to the pilot signal destined for user #1 and N₂^{(CSI)} is assumed to be a power value of noise added as the EVM to the pilot signal destined for user #2. S₁′ is assumed to be a transmission power value of the signal destined for user #1 (that is, a reduced allocation power value of the first terminal 50) and S₂′ is assumed to be a transmission power value of the signal destined for user #2 (that is, a reduced allocation power value of the second terminal 50). N (S₁′, S₂′) is assumed to be a power value of noise added as the EVM to the transmission power value (that is, the reduced transmission power value) of the multiplex signal obtained by multiplexing the signal destined for user #1 and the signal destined for user #2. S₁′ and S₂′ are parameters for changing the power distribution. Since the ratio of the allocation power value S₁ of the first terminal 50 to the allocation power value S₂ of the second terminal 50 is fixed, S₁′ and S₂′ are calculated using S₁′=S₁·(S′/S) and S₂′=S₂·(S′/S), respectively. γ₁^{(CSI)}, γ₂^{(CSI)}, S₁^{(CSI)}, and S₂^{(CSI)} are known values and are managed on the base station 10 side.

That is, the instantaneous SINR calculation section 54 acquires N₁^{(CSI)} corresponding to S₁^{(CSI)}, N₂^{(CSI)} corresponding to S₂^{(CSI)}, and N (S₁′, S₂′) corresponding to S′ as EVM power values with reference to the storage section 18. Then, the instantaneous SINR calculation section 54 applies the acquired N₁^{(CSI)}, N₂^{(CSI)}, and N (S₁′, S₂′) to formulae (11) and (12) to calculate the instantaneous SINRs of the first and second terminals 50.

The total channel capacity calculation section 55 calculates the total channel capacity which is the scheduling index for the terminal combination including the first and second terminals 50 by using the instantaneous SINRs received from the instantaneous SINR calculation section 54. The total channel capacity calculation section 55 corresponds to an example of the second calculation section. For example, the total channel capacity calculation section 55 calculates the total channel capacity for the terminal combination including the first and second terminals 50 by using formula (13) below.

C(S′)=log₂ {1+γ₁(S₁′,S₂′)}+log₂ {1+γ₂(S₁′,S₂′)} (13)

Here, γ₁(S₁′, S₂′) and γ₂(S₁′, S₂′) indicate the instantaneous SINR of the first terminal 50 and the instantaneous SINR of the second terminal 50, respectively.

The allocation decision section 56 re-decides the allocation power value S₁ of the first terminal 50 and the allocation power value S₂ of the second terminal 50 based on the total channel capacity. Specifically, the allocation decision section 56 specifies the reduced transmission power value S′ corresponding to the total channel capacity with the maximum value among the plurality of total channel capacities calculated by the total channel capacity calculation section 55 by using formula (14) below.

$$\hat{{S}^{′}} = arg {max}_{{S}^{′}} C ( {S}^{′} ) \qquad ( 14 )$$

Then, the allocation decision section 56 re-decides the allocation power value S₁ of the first terminal 50 and the allocation power value S₂ of the second terminal 50 by using the specified reduced transmission power value S′ and formulae (15) and (16) below.

$$\begin{matrix}{\hat{S}}_{1} = \frac{\hat{{S}^{′}}}{S} {S}_{1} & ( 15 ) \\ {\hat{S}}_{2} = \frac{\hat{{S}^{′}}}{S} {S}_{2} & ( 16 )\end{matrix}$$

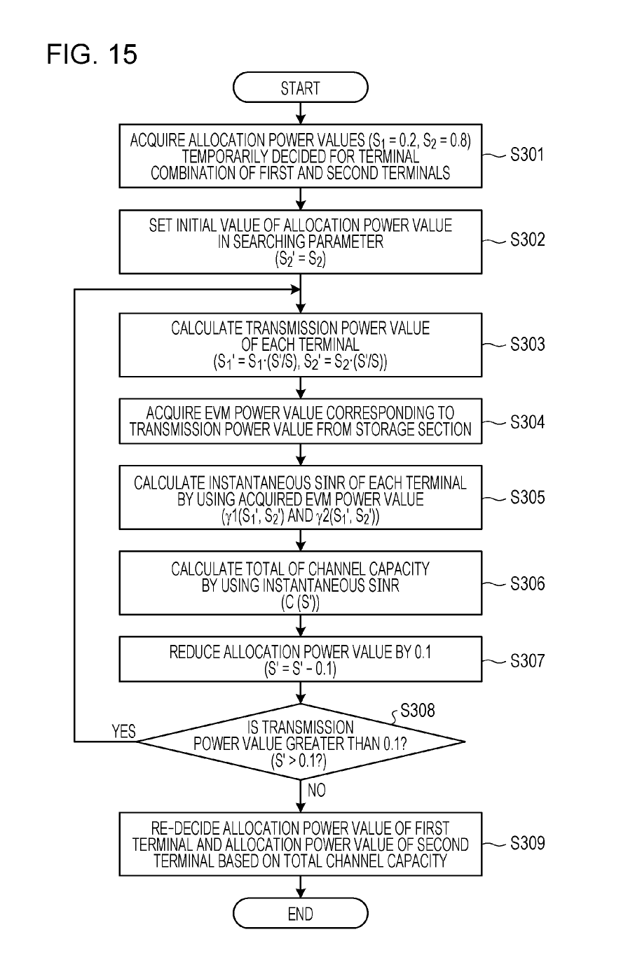

Next, an example of a processing operation of the radio communication system according to Embodiment 3 will be described. In particular, an allocation power decision method by the scheduler 19 of the base station 10 will be described. FIG. 15 is a flowchart illustrating the flow of a process of an allocation power decision method according to Embodiment 3.

As illustrated in FIG. 15, the instantaneous SINR calculation section 54 acquires the allocation power value S₁ of the first terminal 50 and the allocation power value S₂ of the second terminal 50, which are temporarily decided for the terminal combination including the first and second terminals 50, from the allocation decision section 53 (S301). Here, 0.2 is decided as the allocation power value S₁ of the first terminal 50 and 0.8 is decided as the allocation power value S₂ of the second terminal 50.

The instantaneous SINR calculation section 54 sets an initial value 1.0 of the transmission power value S which is a sum of the allocation power value S₁ of the first terminal 50 and the allocation power value S₂ of the second terminal 50 in a searching parameter (S302). The searching parameter is a parameter used to search for the reduced transmission power value S′.

The instantaneous SINR calculation section 54 calculates the reduced allocation power value S₁′ of the first terminal 50 and the reduced allocation power value S₂′ of the second terminal 50 (S303).

The instantaneous SINR calculation section 54 acquires from the storage section 18 the EVM power value corresponding to the reduced transmission power value S′ (S304).

The instantaneous SINR calculation section 54 calculates an instantaneous SINR for each of the first and second terminals 50 by using the acquired EVM power value (S305). That is, the instantaneous SINR calculation section 54 calculates the instantaneous SINR of each of the first and second terminals 50 by applying the acquired EVM power value to each of formulae (11) and (12) above.

The total channel capacity calculation section 55 calculates the total channel capacity which is the scheduling index for the terminal combination including the first and second terminals 50 by using the instantaneous SINRs received from the instantaneous SINR calculation section 54 (S306). That is, the total channel capacity calculation section 55 calculates the total channel capacity for the terminal combination including the first and second terminals 50 by using formula (13) above.

The instantaneous SINR calculation section 54 reduces the transmission power value S which is the sum of the allocation power value S₁ of the first terminal 50 and the allocation power value S₂ of the second terminal 50 by 0.1 in the fixed state of the ratio of the allocation power value S₁ of the first terminal 50 to the allocation power value S2 of the second terminal 50 (S307). The reduction amount of the transmission power value S is not limited to 0.1.

The instantaneous SINR calculation section 54 returns to the process of S303 when the reduced transmission power value S′ is greater than 0.1 (YES in S308).

The instantaneous SINR calculation section 54 allows the process to proceed to S309 when the reduced transmission power value S′ is equal to or less than 0.1 (NO in S308).

The allocation decision section 56 re-decides the allocation power value S₁ of the first terminal 50 and the allocation power value S₂ of the second terminal 50 based on the total channel capacity (S309). Specifically, the allocation decision section 56 specifies by using formula (14) above the reduced transmission power value S′ corresponding to the total channel capacity with the maximum value among the plurality of total channel capacities calculated by the total channel capacity calculation section 55. Then, the allocation decision section 56 re-decides the allocation power value S₁ of the first terminal 50 and the allocation power value S₂ of the second terminal 50 by using the specified reduced transmission power value S′ and formulae (15) and (16) above.

According to the embodiment, as described above, the instantaneous SINR calculation section 54 in the base station 10 acquires the allocation power value S₁ of the first terminal 50 and the allocation power value S₂ of the second terminal 50 which are temporarily decided without using the EVM power value for the terminal combination including the first and second terminals 50. Then, the instantaneous SINR calculation section 54 reduces the transmission power value S which is the sum of the allocation power value S₁ of the first terminal 50 and the allocation power value S₂ of the second terminal 50 in the fixed state of the ratio of the allocation power value S₁ of the first terminal 50 to the allocation power value S2 of the second terminal 50. Then, the instantaneous SINR calculation section 54 acquires the EVM power value corresponding to the reduced transmission power value S′ from the storage section 18. The instantaneous SINR calculation section 54 calculates an instantaneous SINR for each of the first and second terminals 50 by using the acquired EVM power value. The total channel capacity calculation section 55 calculates the total channel capacity which is the scheduling index for the terminal combination including the first and second terminals 50 by using the instantaneous SINRs received from the instantaneous SINR calculation section 54. The allocation decision section 56 re-decides the allocation power value S₁ of the first terminal 50 and the allocation power value S₂ of the second terminal 50 based on the total channel capacity.

In the configuration of the base station 10, the scheduling index in consideration of the EVM is calculated for the terminal combination including two terminals. Therefore, the terminal combinations of scheduling index calculation targets may be narrowed down. As a result, according to the embodiment, it is possible to improve the deterioration in the total channel capacity caused due to the EVM and it is possible to reduce an amount of calculation to calculate the scheduling index.

### Other Embodiments

The constituent elements of the sections illustrated in the embodiments may not necessarily be configured physically as illustrated. That is, specific distributed or integrated forms of the sections are not limited to the illustrated forms, but some or all of the sections may be configured to be distributed or integrated functionally or physically in any units in accordance with various loads, use situations, or the like.

Further, some or all of the various processing functions performed by the devices may be performed on a central processing unit (CPU) (or a microprocessor such as a micro processing unit (MPU) or a micro controller unit (MCU)). Some or all of the various processing functions may be performed on a program analyzed and executed by a CPU (or a microprocessor such as an MPU or an MCU) or on hardware by wired logic.

The base stations according to the Embodiments 1 to 3 may be realized by, for example, the following hardware configuration.

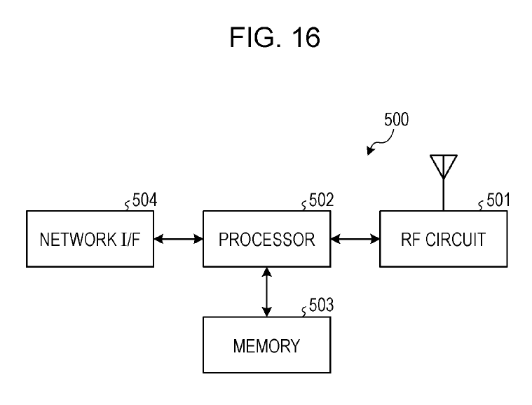

FIG. 16 is a diagram illustrating an example of a hardware configuration of a base station. As illustrated in FIG. 16, a base station 500 includes a radio frequency (RF) circuit 501, a processor 502, a memory 503, a network interface (IF) 504. Examples of the processor 502 include a CPU, a digital signal processor (DSP), and a field programmable gate array (FPGA). Examples of the memory 503 include a RAM such as a synchronous dynamic random access memory (SDRAM), a ROM, and a flash memory. The base stations according to Embodiments 1 to 3 each have the configuration illustrated in FIG. 16.

The various processing functions performed by the base stations according to Embodiments 1 to 3 may be realized by causing a processor included in an amplifier device to execute a program stored in any of various memories such as a nonvolatile storage medium. That is, a program corresponding to each of the processes performed by the NOMA multiplexing section 11, the channel multiplexing section 12, the OFDM transmission processing section 13, the reception processing section 16, the extraction section 17, the storage section 18, the scheduler 19, and the control signal generation section 20 may be recorded on the memory 503 to be executed by the processor 502. The radio transmission section 14 and the radio reception section 15 are realized by the RF circuit 501.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication device, comprising:
a memory configured to store and associate a transmission power value of a signal and an error vector magnitude (EVM) power value which is a power value of noise corresponding to EVM; and
a processor coupled with the memory, and configured to:
acquire the EVM power value corresponding to the transmission power value of the signal destined for a terminal group of a scheduling target from the memory and
perform, by using the acquired EVM power value, a scheduler process of deciding a terminal combination which is a power allocation target and an allocation power value of each terminal of the decided terminal combination from a plurality of terminal combinations in the terminal group of the scheduling target, wherein
the communication device is configured to be applied with a non-orthogonal multiple access scheme.

2. The communication device according to claim 1,
wherein the processor is configured to perform the scheduler process including:
a first calculation process of acquiring the EVM power value corresponding to the transmission power value of the signal destined for the terminal group of the scheduling target from the memory and calculating an instantaneous signal to interference plus noise ratio (SINR) for each terminal in the terminal group of the scheduling target by using the acquired EVM power value,
a second calculation process of calculating a scheduling index for each of the plurality of terminal combinations in the terminal group of the scheduling target by using the instantaneous SINR, and
a decision process of deciding the terminal combination which is the power allocation target and the allocation power value of each terminal of the decided terminal combination from the plurality of terminal combinations based on the scheduling index.

3. The communication device according to claim 2, wherein
in the first calculation process:
an allocation power value of a first terminal and an allocation power value of a second terminal greater than the allocation power value of the first terminal which are temporarily decided without using the EVM power value are acquired for a terminal combination including the first and second terminals,
the allocation power value of the second terminal is reduced,
an EVM power value corresponding to a transmission power value, which is a sum of the reduced allocation power value of the second terminal and the allocation power value of the first terminal which is a fixed value, is acquired from the memory, and
an instantaneous SINR is calculated for each of the first and second terminals by using the acquired EVM power value,
in the second calculation process, a scheduling index is calculated for the terminal combination including the first and second terminals by using the instantaneous SINR, and
in the decision process, the allocation power value of the second terminal is re-decided based on the scheduling index.

4. The communication device according to claim 2, wherein
in the first calculation process:
an allocation power value of each of three or more terminals which are temporarily decided without using the EVM power value is acquired for a terminal combination including the three or more terminals,
the allocation power value of the terminal with a maximum allocation power value among the allocation power values of the three or more terminals is reduced,
an EVM power value corresponding to a transmission power value, which is a sum of the reduced maximum allocation power value of the terminal and the allocation power values of the other terminals which are fixed values, is acquired from the memory, and
an instantaneous SINR is calculated for each of the three or more terminals by using the acquired EVM power value,
in the second calculation process, a scheduling index is calculated for the terminal combination including the three or more terminals by using the instantaneous SINR, and
in the decision process, the maximum allocation power value of the terminal is re-decided based on the scheduling index.

5. The communication device according to claim 2, wherein
in the first calculation process:
an allocation power value of a first terminal and an allocation power value of a second terminal which are temporarily decided without using the EVM power value are acquired for the terminal combination including the first and second terminals,
a transmission power value which is a sum of the allocation power value of the first terminal and the allocation power value of the second terminal is reduced in a fixed state of a ratio of the allocation power value of the first terminal to the allocation power value of the second terminal,
an EVM power value corresponding to the reduced transmission power value is acquired from the memory, and
an instantaneous SINR is calculated for each of the first and second terminals by using the acquired EVM power value,
in the second calculation process, a scheduling index is calculated for the terminal combination including the first and second terminals based on the instantaneous SINR, and
in the decision process, the allocation power value of the first terminal and the allocation power value of the second terminal are re-decided based on the scheduling index.

6. A scheduling method executable by a processor coupled with a memory in a communication device to which a non-orthogonal multiple access scheme is applied, the method comprising:
acquiring an error vector magnitude (EVM) power value corresponding to a transmission power value of a signal destined for a terminal group of a scheduling target from the memory storing the EVM power value which is a power value of noise corresponding to EVM in association with the transmission power value of the signal, and
deciding a terminal combination which is a power allocation target and an allocation power value of each terminal of the decided terminal combination from a plurality of terminal combinations in the terminal group of the scheduling target by using the acquired EVM power value.
